(19) United States
(12) Patent Application Publication
(10) Pub. No.: US 2015/0202564 A1
(43) Pub. Date: Jul. 23, 2015

(54) Method For Permeation Extraction of Hydrogen From an Enclosed Volume

(71) Applicants: Robert E. Kirby, Cupertino, CA (US); Gregory A. Mulhollan, Dripping Springs, TX (US); John C. Bierman, Austin, TX (US)

(72) Inventors: Robert E. Kirby, Cupertino, CA (US); Gregory A. Mulhollan, Dripping Springs, TX (US); John C. Bierman, Austin, TX (US)

(21) Appl. No.: 14/159,812

(22) Filed: Jan. 21, 2014

(51) Int. Cl. B01D 53/22

(52) U.S. Cl. CPC B01D 53/228; B01D 2053/222

(57) ABSTRACT

A method by which a gold-coated palladium foil, singly or in combination with metal oxides, can be made to permanently remove hydrogen gas from an attached vacuum chamber, either electrically-passive or electrically-active has been discovered. The foil assembly (301) is secured onto a demountable or permanently affixed flange (303), through which hydrogen gas passes via permeation (102), from the vacuum chamber being pumped (401), to atmosphere. Palladium combined with a metal oxide (502), secondary metal layer (503), gold coating (504) and an applied voltage (509) increases the pumping speed. Methods associated with this claim include the foil mounting and sealing, configuring film composition and applying requisite bias voltage.

### CROSS-REFERENCE TO RELATED APPLICATION

This application claims the benefit of PPA Ser. No. 61/849,072 filed Jan. 22, 2013 by the present inventors, which is incorporated by reference.

### FEDERALLY SPONSORED RESEARCH

This work was supported by the Department of Energy SBIR under Grant No. DE-SC0009542.

### FIELD OF THE INVENTION

This application relates to a method by which a gold-coated palladium foil, singly or in combination with metal oxides, can be made to permanently remove hydrogen gas from an attached vacuum chamber, either electrically-passive or electrically-active. Specifically, the method relates to the mounting and sealing, setting film thickness, composition and microstructure and applying requisite bias voltage.

BACKGROUND

Vacuum generation encompasses a wide variety of techniques and is employed in large numbers of technological endeavors. Sputter deposition, particle beam generation and low friction encapsulated micro-machine environments are possible through vacuum generation. The operative vacuum range (high: 1×10⁻³−1×10⁻⁶ Torr, very high: 1×10⁻⁶−1×10⁻⁹ Torr, ultra-high (UHV): 1×10⁻⁹−1×10⁻¹² Torr and extreme-high (XHV): <1×10⁻¹² Torr) determines the available vacuum pumps, as there are no pumps capable of covering the entire range alone. At the lowest end, XHV, the vacuum pump choices are fewer still even as the technology reliant upon achieving that vacuum level becomes more prevalent. XHV is most commonly utilized in photoinjectors for particle physics laboratories. However, as producing XHV becomes more desirable for its potential in the production of micro-engineered machines and extreme ultraviolet mask patterning lithography, need for improved pumping solutions will exist.

XHV is defined as the pressure range less than 0.75×10⁻¹² Torr (=1×10⁻¹² mbar=1×10⁻¹⁰ Pascal).

Although producing XHV conditions requires a careful choice of system materials, extensive material processing and complex pumping schemes, the difficult task of actually determining the pressure is also a serious limitation in the routine use of XHV conditions. At XHV the primary gas is hydrogen, meaning that measuring the hydrogen pressure represents the total pressure with at most a few percent error and that a pump which efficiently removes hydrogen from a volume has a major impact on the system pressure. Hydrogen is always present in clean vacuum systems because it diffuses through the vacuum chamber walls while other gases, such as carbon monoxide/dioxide and hydrocarbons do not. Hydrogen permeation can be reduced by coating the chamber interior with a diffusion-barrier film, such as titanium nitride. Pumping techniques for producing XHV include utilizing some of the same pumps used in UHV.

Efficient pumping of the hydrogen-dominated XHV environment to lower pressures calls for a completely new solution to be envisioned. The XHV environment is characterized by very low residual gas pressure (<10⁻¹² Torr) and a low outgassing rate of the chamber inner wall. Such conditions are essential for particle and hydrocarbon-free environments, for example, production of multi-layer x-ray mirrors for free-electron lasers. High pumping speeds alone are not sufficient to prevent contamination, so low outgassing is essential to prevent the buildup of hydrocarbons on sensitive surfaces. The pumping techniques required to reach UHV conditions (sputter-ion, cascaded turbomolecular, cryogenic, and non-evaporable getter pumps) impede further reduction to a clean XHV environment by either re-emitting condensed or chemically-stored pumped gas (cryogenic, sputter-ion, and getter) or allowing backstreaming of exhaust gas (turbomolecular). It is desirable to isolate these pumps, by valving them out of circuit, after attainment of the low UHV environment whence a condition of almost pure hydrogen residual gas exists. At that point, a hydrogen gas-specific pump is sufficient to continue to lower XHV pressures.

### SUMMARY OF THE INVENTION

An object of the invention is to overcome at least some of the drawbacks relating to the methods of prior art as discussed above.

Hence, a method by which a gold-coated palladium foil, singly or in combination with metal oxides, can be made to permanently remove hydrogen gas from an attached vacuum chamber, either electrically-passive or electrically-active. Conventional methods employ the use internal capture or exhaustion through a momentum barrier rather than a chemical transport barrier, thereby either reemitting pumped gasses later or allowing admittance of previously exhausted gasses at very low pressures.

In the improved pumping method, hydrogen gas is permanently removed from the system via permeation through a palladium foil or membrane. The pump consists of a hydrogen-transparent window membrane, constructed of a thin Pd foil, capable of withstanding a differential pressure of up to two atmospheres. The upstream side of the membrane is exposed directly to the XHV vacuum, while downstream is connected to a small exterior volume. The exterior volume is continuously micro-flushed with inert gas, supplied and . exhausted through adjustable conductance limiting geometries, and whose purpose is to flush away permeated hydrogen from the exterior surface of the membrane.

The pumping action is facilitated by the properties of the gold coating on the palladium surface. While allowing hydrogen molecules to exit, it inhibits the disassociative action of the clean palladium surface on the inlet side of the pump by allowing physisorption onto only the gold surface. Reconstituted hydrogen molecules, however, can diffuse through the thin gold layer outward, where the kinetic impact of the flushing gas sweeps them away and keeps any partial pressure of hydrogen molecules from having sufficiently long dwell time upon the gold surface to find their way into the gold layer and hence reverse the pumping action.

Continued hydrogen absorption on the inlet side leads to elevated hydrogen concentrations within the palladium foil and thereby introduces a concentration gradient resulting in diffusion through the foil with a virtual one-way door established on the opposing side by virtue of the gold layer action. A chemical cleansing agent can be brought to the inlet side of the palladium foil surface via energetic or thermal energy ion or by neutral atomic interaction thereby reducing any inhibitory materials on the palladium surface, allowing it to react with the surface with a higher disassociation rate.

In other aspects, the invention provides a permeation based method of removing hydrogen from a vacuum chamber having features and advantages corresponding to those discussed above.

### BRIEF DESCRIPTION OF THE DRAWINGS

The present invention is illustrated by way of example and not limitation in the accompanying figures:

FIG. 1 shows the hydrogen partial pressure change on the palladium foil output side (vertical axis), as measured by a mass spectrometer, caused by an increase (horizontal axis) in hydrogen pressure on the input side.

FIG. 2 schematically represents the operational behavior of the gold-coated palladium foil hydrogen pump exposed to gas on its input.

FIG. 3. represents the assembly of a palladium foil pump sealed with a metal gasket between two vacuum flanges.

FIG. 4. schematically shows the connection of a palladium foil pump between a hydrogen-containing chamber and a gas flushing assembly for removing pumped hydrogen to atmosphere.

FIG. 5. schematically represents a voltage-biased electro-diffusion model of a palladium-metal oxide-palladium-gold pump structure for enhancing pumping speed.

### DETAILED DESCRIPTION OF THE INVENTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

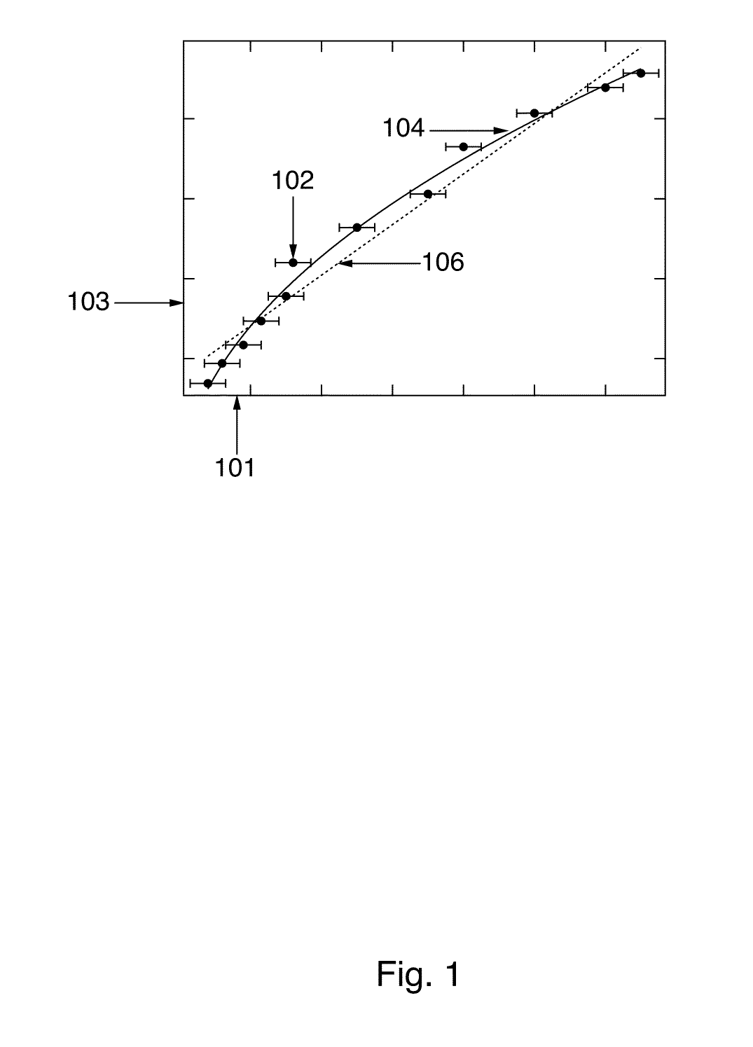

FIG. 1 illustrates the hydrogen pressure 102 response obtained from a gold 202 coated palladium 201 foil when an overpressure of hydrogen 203 is administered to the upstream side using the methods familiar to practitioners of the art. The abscissa 101 represents the inlet hydrogen pressure and the ordinate 103 represents the hydrogen output partial pressure. The abscissa 101 covers a pressure range of 0.0 through 13 millliTorr. The ordinate 103 covers a pressure range of 4.5 to 8.5×10⁻⁷ Torr. The hydrogen partial pressure, as obtained from a quadrupole mass spectrometer, was generated by decreasing the inlet pressure over a short time period. Upon extracting the permeation induced pressure 103 (proportional to permeation rate) and the inlet pressure 101 (proportional to impingement rate), the values 102 were obtained. Fits to the data 102 were linear 106 (poor) and power law 104 (excellent). The free-floating power exponent minimized to a value of 0.48 (½), indicating the hydrogen permeation was bulk diffusion limited within the palladium foil 201. Permeation driven hydrogen transport 206 is enhanced by increasing the palladium foil temperature.

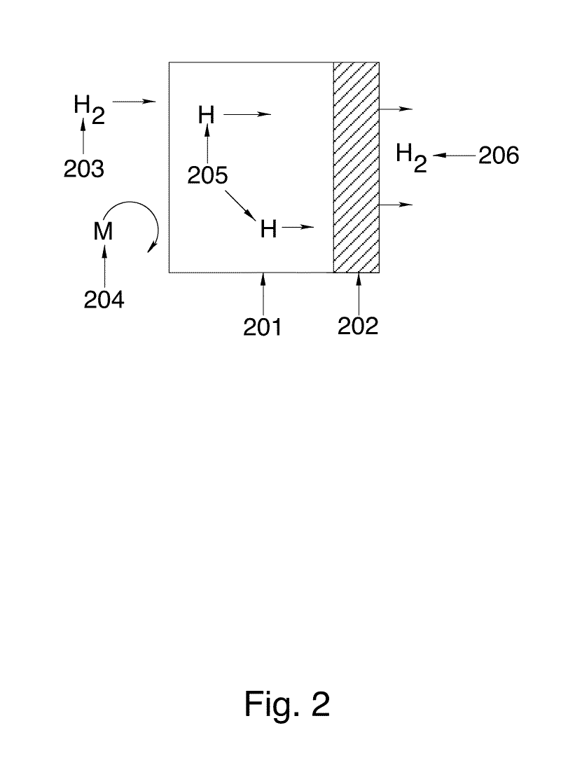

Turning now to FIG. 2, the method of zero bias permeation, as one embodiment of the method, is depicted. Hydrogen gas molecules 203 impinge on the upstream (inlet) side of a palladium foil 201. Other species 204 are not active in a meaningful way with the the palladium 201. Following physisorption, a high probability of disassocation of the hydrogen molecule 203 into neutral atoms 205 exists. The hydrogen atoms 205 diffuse through the palladium 201 foil until any concentration gradient is erased. At the downstream (exit) side of the palladium foil, a gold layer 202, comprised of several atomic layers, effects a change transport properties of the hydrogen atoms 205. At the interface between the palladium 201 and the gold 202 and outwards, the atomic hydrogen 205 may recombine into molecular hydrogen. Absent of further palladium 201 interaction, the diatomic molecule may migrate to the exit side of the composite and depart as an intact molecule 206. The gold surface 202 is non-disassociative with respect to hydrogen 206, so no new hydrogen atoms 205 are reinjected into the composite from the downstream side.

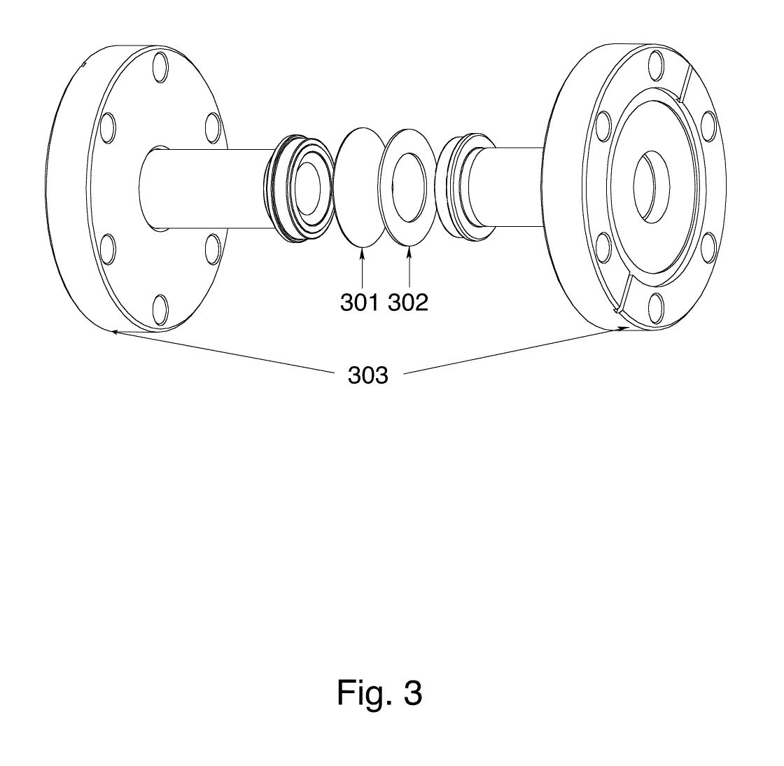

An example assembly incorporating the method for mechanical mounting and vacuum connection is illustrated in FIG. 3. The composite foil 301 is clamped between two sealing surfaces 303 suitable for attaining UHV and XHV pressures. The foil 301 is sufficiently thick that it is overpressure safe, withstanding at least a two atmosphere differential. As a mechanical brace and a sealing aid, one gasket 302 may be included in the assembly. The foils, in this embodiment, may be recycled a number of times, i.e, the assembly broken down and reassembled, with progressively higher sealing pressures required to again achieve UHV and XHV compatible leak rates. The vacuum flanges 303 permit connection to standard systems in the manner familiar to practitioners of the art. The opposing side of the assembly provides the connection facilitating the flushing gas flow past the exit side of the composite foil 301.

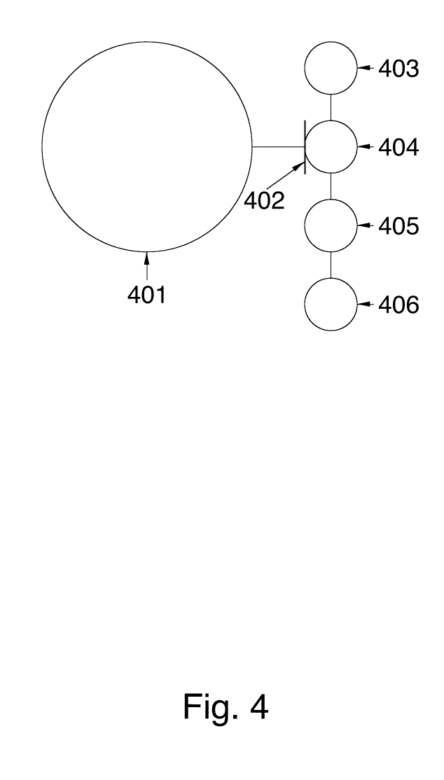

FIG. 4 illustrates a method for attaching and operating the composite foil 402 permeation based pump as a system to a vacuum chamber 401. A connection of sufficient conductance is established between the vacuum chamber 401 and the properly affixed composite foil 402. A source of flushing gas 406 is attached to a metering valve 405 or other flow control device. The metered flushing gas passes into the exit side coupled volume 404 and out through a second metering valve 403. In this embodiment, the gold 202 coated palladium foil 201 is employed in the zero bias configuration.

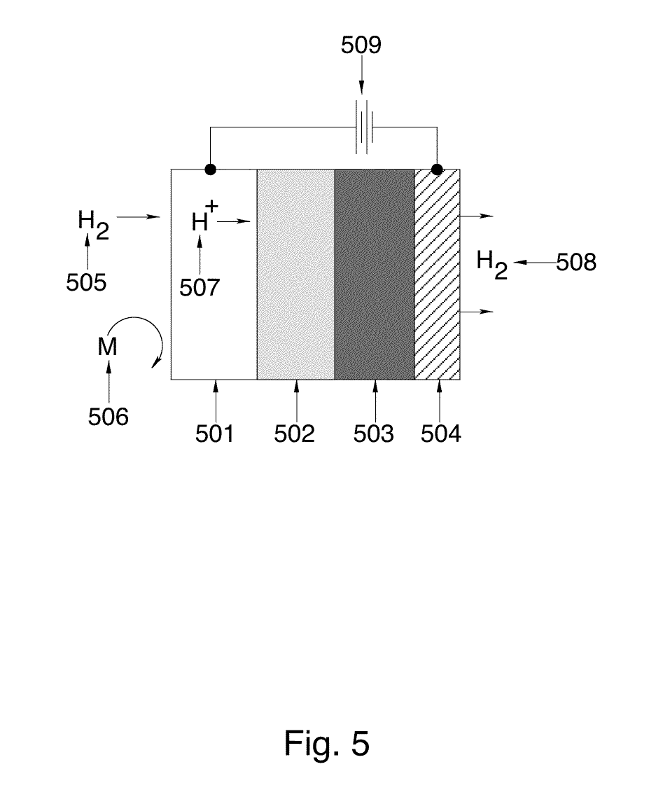

Turning now to FIG. 5, the bias driven embodiment is illustrated. As before, hydrogen molecules 505 are incident upon a palladium foil 501, with other species 506 not reacting in a meaningful way. At the surface of the palladium 501, the hydrogen molecules 505 decompose into hydrogen atoms, with a fraction remaining as bare protons 507. A bias 509 is held across a metal oxide 502 layer which in turn creates a potential difference from the entry side palladium 501 and the exit side palladium 503. The transport of the hydrogen ions 507 is enhanced by the non-zero electric bias voltage 509. Once the hydrogen ions arrive at the exit side palladium 503, they may then recombine and diffuse through the gold overlayer 504 exiting as in the previous embodiment as hydrogen molecules 508. The downstream side palladium layer, 503, also acts as a gold atom diffusion barrier to ameliorate gold loss from the downstream surface. The flushing gas action remains the same and serves to minimize the residence time of the hydrogen molecule at the exit surface, reducing the probability of reentry to a very low value.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A method of permanently removing hydrogen gas from a vacuum chamber, the method comprising: providing a gold-coated palladium foil, wherein the treated foil causes removal of hydrogen gas by permeation.

2. The method according to claim 1, wherein the composite foil has a metal layer between the gold and palladium.

3. The method according to claim 1, wherein the composite foil has a metal oxide layer between a gold coated palladium layer and the palladium foil.

4. The method according to claim 1, wherein the composite foil is held at a temperature between 30° C. and 150° C.

5. The method according to claim 1, wherein the foil is held at a temperature between 150° C. and 250° C.

6. The method according to claim 1, wherein the exhausting gas is neon.

7. The method according to claim 1, wherein the exhausting gas is argon.

8. The method according to claim 1, wherein the exhausting gas is krypton.

9. The method according to claim 1, wherein the exhausting gas is oxygen.

10. The method according to claim 1, wherein the exhausting gas is nitrogen.

11. The method according to claim 1, wherein the composite foil is operated without an applied bias voltage.

12. The method according to claim 1, wherein the composite foil is operated with an applied bias voltage between 0 and 100 V.

13. The method according to claim 1, wherein the composite foil is operated with an applied bias voltage between 100 and 1000 V.

14. The method according to claim 1, wherein the composite foil is affixed by clamping between two sealing surfaces without additional material.

15. The method according to claim 1, wherein the composite foil is affixed by clamping between two sealing surfaces with a buffer gasket on the high pressure side.

16. The method according to claim 1, wherein the composite foil is affixed by clamping between two sealing surfaces with a buffer gasket on the low pressure side.

17. The method according to claim 1, wherein the composite foil is affixed by welding to a suitable metal substrate.

18. The method according to claim 1, wherein the composite foil is affixed by brazing to a suitable metal substrate

19. The method according to claim 1, wherein a multiple of the composite foils are affixed in a topologically parallel arrangement.

20. The method according to claim 1, wherein the hydrogen uptake rate is increased by in situ cleaning of the admitting surface.
